(19) United States
(12) Patent Application Publication
(10) Pub. No.: US 2016/0246110 A1
(43) Pub. Date: Aug. 25, 2016

(54) PIXEL STRUCTURE AND DISPLAY DEVICE

(71) Applicant: Shenzhen China Star Optoelectronics Technology Co., Ltd., Shenzhen, Guangdong (CN)

(72) Inventors: Feng Zhao, Shenzhen, Guangdong (CN); Yuzhi Wu, Shenzhen, Guangdong (CN)

(73) Assignee: Shenzhen China Star Optoelectronics Technology Co., Ltd., Shenzhen, Guangdong (CN)

(21) Appl. No.: 14/418,601

(22) PCT Filed: Jan. 19, 2015
(86) PCT No.: PCT/CN2015/070968

§ 371 Date: May 9, 2016

(30) Foreign Application Priority Data
Dec. 31, 2014 (CN) 201410855530.4

(51) Int. Cl. G02F 1/1335; G02F 1/1343

(52) U.S. Cl. CPC G02F 1/133516; G02F 1/133514; G02F 1/134309; G02F 2001/134345

(57) ABSTRACT

A pixel structure and a display device are disclosed. The present disclosure relates to the technical field of display, whereby the technical problem that the manufacturing of the color filter substrate with four-color pixels is complicated can be solved. The pixel structure comprises sub pixels with four different colors, wherein: a first sub pixel is provided with a first color-resist; a second sub pixel is provided with a second color-resist; a third sub pixel is provided with a third color-resist; and a fourth sub pixel is provided with any two of the first color-resist, the second color-resist, and the third color-resist.

### CROSS REFERENCE TO RELATED APPLICATION

The present application claims benefit of Chinese patent application CN 201410855530.4, entitled “Pixel Structure and Display Device” and filed on Dec. 31, 2014, the entirety of which is incorporated herein by reference.

### FIELD OF THE INVENTION

The present disclosure relates to the technical field of display, and particularly to a pixel structure and a display device.

### BACKGROUND OF THE INVENTION

With the development of display technology, the liquid crystal display device has become the most commonly used display device.

The liquid crystal display device is made of a plurality of pixels. The traditional three-color pixels generally comprise red sub pixel, green sub pixel, and blue sub pixel, whereby only three primary colors, i.e., the red color, the green color, and the blue color, can be generated. Therefore, the color gamut thereof is relatively narrow. When another color other than the red color, the green color, or the blue color needs to be presented, two of the three primary colors or three thereof should be mixed with each other. For example, when the yellow color needs to be presented, the red sub pixel and the green sub pixel should be turned on simultaneously and mixed together.

Compared with three-color pixels, four-color pixels comprise sub pixels with four different colors, such as the red sub pixel, the yellow sub pixel, the green sub pixel, and the blue sub pixel, and thus the color gamut thereof is relatively wide. During display procedures, color mixing modes can be used less. For example, when the yellow color is to be presented, the yellow sub pixel needs to be turned on only. Therefore, the power consumption thereof is lower than the display device with three-color pixels.

However, during the manufacturing of four-color pixels, it is necessary to coat color-resists of four different colors in sequence on the color filter substrate, and thus the manufacturing of the color filter substrate is relatively complicated.

### SUMMARY OF THE INVENTION

The purpose of the present disclosure is to provide a pixel structure and a display device with which the complicated manufacturing procedure of the color filter substrate with four-color pixels can be carried out much easier.

The present disclosure provides a pixel structure, comprising sub pixels with four different colors, wherein: a first sub pixel is provided with a first color-resist; a second sub pixel is provided with a second color-resist; a third sub pixel is provided with a third color-resist; and a fourth sub pixel is provided with any two of said first color-resist, said second color-resist, and said third color-resist.

Preferably, in said fourth sub pixel, two color-resists have a same area.

Further, said first sub pixel is a red sub pixel, and said first color-resist is a red color-resist; said second sub pixel is a green sub pixel, and said second color-resist is a green color-resist; and said third sub pixel is a blue sub pixel, and said third color-resist is a blue color-resist.

In one embodiment, said fourth sub pixel is a yellow sub pixel, and said yellow sub pixel is provided with the red color-resist and the green color-resist.

Preferably, said yellow sub pixel is arranged between said red sub pixel and said green sub pixel.

In a second embodiment, said fourth sub pixel is a violet sub pixel, and said violet sub pixel is provided with the red color-resist and the blue color-resist.

Preferably, said violet sub pixel is arranged between said red sub pixel and said blue sub pixel.

In a third embodiment, said fourth sub pixel is a cyan sub pixel, and said cyan sub pixel is provided with the blue color-resist and the green color-resist.

Preferably, said cyan sub pixel is arranged between said blue sub pixel and said green sub pixel.

The present disclosure further provides a display device, which comprises a plurality of pixel units, and each of said pixel units comprises a pixel structure as aforementioned.

The following beneficial effects can be brought about by the present disclosure. According to the present disclosure, the pixel structure comprises sub pixels with four different colors. Since the color-resist in the fourth sub pixel is formed by two color-resists of the traditional three color-resists, in the pixel structure according to the present disclosure, the sub pixels with four different colors can be realized by the color-resists of three colors. Therefore, it is only necessary to coat color-resists of three colors on the color filter substrate during the manufacturing. In this manner, the manufacturing procedure of the color filter substrate with four-color pixels can be simplified, and thus the technical problem that the manufacturing of the color filter substrate with four-color pixels is complicated can be solved.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The drawings necessary for explaining the embodiments are introduced briefly below to illustrate the technical solutions of the embodiments of the present disclosure more clearly.

FIG. 1 is a plan view of a pixel structure according to Embodiment 1 of the present disclosure;

FIG. 2 is a sectional view of the pixel structure according to Embodiment 1 of the present disclosure;

FIG. 3 is a plan view of a pixel structure according to Embodiment 2 of the present disclosure;

FIG. 4 is a sectional view of the pixel structure according to Embodiment 2 of the present disclosure;

FIG. 5 is a plan view of a pixel structure according to Embodiment 3 of the present disclosure; and

FIG. 6 is a sectional view of the pixel structure according to Embodiment 3 of the present disclosure.

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It should be noted that, as long as there is no structural conflict, all the technical features mentioned in all the embodiments may be combined together in any manner, and the technical solutions obtained in this manner all fall within the scope of the present disclosure.

The embodiments of the present disclosure provide a pixel structure, which comprises sub pixels with four different colors, wherein: a first sub pixel is provided with a first color-resist; a second sub pixel is provided with a second color-resist; a third sub pixel is provided with a third color-resist; and a fourth sub pixel is provided with any two of the first color-resist, the second color-resist, and the third color-resist.

According to the present disclosure, the pixel structure comprises sub pixels with four different colors. Since the color-resist in the fourth sub pixel is made of two color-resists of the traditional three color-resists, in the pixel structure according to the embodiments of the present disclosure, the sub pixels with four different colors can be realized by the color-resists of three colors. Therefore, it is only necessary to coat color-resists of three colors on the color filter substrate during the manufacturing. In this manner, the manufacturing procedure of the color filter substrate with four-color pixels can be simplified, the technical problem that the manufacturing of the color filter substrate with four-color pixels is complicated can be solved, and thus the production efficiency thereof can be improved.

### Embodiment 1

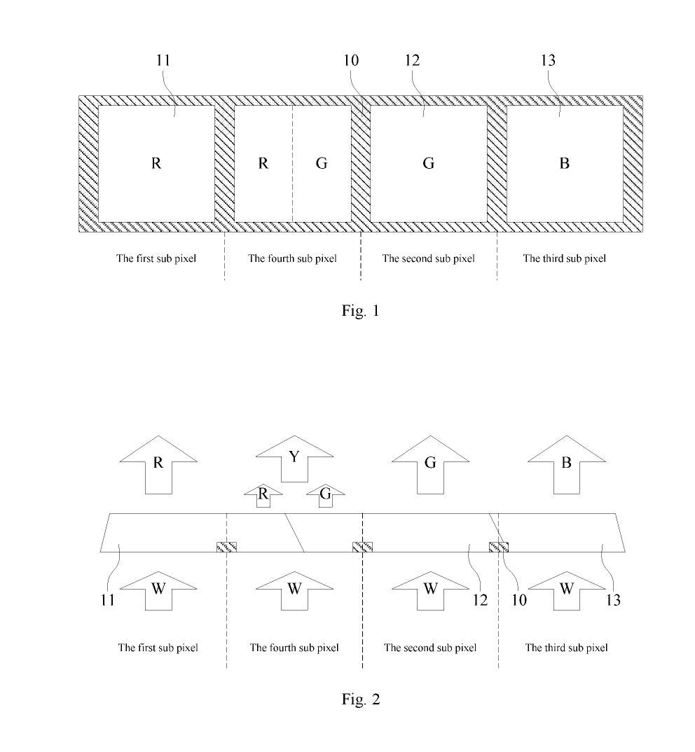

As shown in FIGS. 1 and 2, the embodiment of the present disclosure provides a pixel structure, which comprises sub pixels with four different colors. The first sub pixel is a red (R) sub pixel and provided with a red color-resist 11; the second sub pixel is a green (G) sub pixel and provided with a green color-resist 12; and the third sub pixel is a blue (B) sub pixel and provided with a blue color-resist 13. The fourth sub pixel is a yellow (Y) sub pixel and provided with the red color-resist 11 and the green color-resist 12. In addition, the pixel structure further comprises a black matrix 10 that is used for separating two adjacent sub pixels.

When an image is displayed, the backlight emits white (W) light. The white light is filtered by the red color-resist 11 when passing through the first sub pixel, and thus only red light transmits from the first sub pixel. The white light is filtered by the green color-resist 12 when passing through the second sub pixel, and thus only green light transmits from the second sub pixel. The white light is filtered by the blue color-resist 13 when passing through the third sub pixel, and thus only blue light transmits from the third sub pixel. The white light is filtered by the red color-resist 11 and the green color-resist 12 respectively when passing through the fourth sub pixel, and thus red light and green light transmit from the fourth sub pixel. The red light and the green light are then mixed into yellow light.

According to the present embodiment, in the fourth sub pixel, the red color-resist 11 and the green color-resist 12 have a same area. That is, the red color-resist 11 and the green color-resist 12 both account for a half of the fourth sub pixel. In this case, the red light transmitted from the fourth sub pixel and the green light transmitted from the fourth sub pixel have the same area, so that the color shift of the yellow light mixed therein can be reduced.

As a preferred solution, the fourth sub pixel is arranged between the first sub pixel and the second sub pixel. That is, the yellow sub pixel is arranged between the red sub pixel and the green sub pixel. In this manner, the red color-resist in the fourth sub pixel and the red color-resist in the first sub pixel can be formed into one piece, and the green color-resist in the fourth sub pixel and the green color-resist in the second sub pixel can also be formed into one piece, so that the patterning procedure during the manufacturing of the color filter substrate can be simplified.

In the pixel structure according to the embodiment of the present disclosure, the sub pixels with four different colors can be realized by the color-resists of three colors. Therefore, the color gamut thereof is widened, and the power consumption during display can be reduced. During the manufacturing of the color filter substrate, after the black matrix is formed, only the color-resists of three colors need to be formed in sequence. In this manner, the manufacturing procedure of the color filter substrate with four-color pixels can be simplified, the technical problem that the manufacturing of the color filter substrate with four-color pixels is complicated can be solved, and thus the production efficiency thereof can be improved. Moreover, no yellow color-resist is used during the manufacturing of the color filter substrate, and thus the material cost thereof can be reduced.

### Embodiment 2

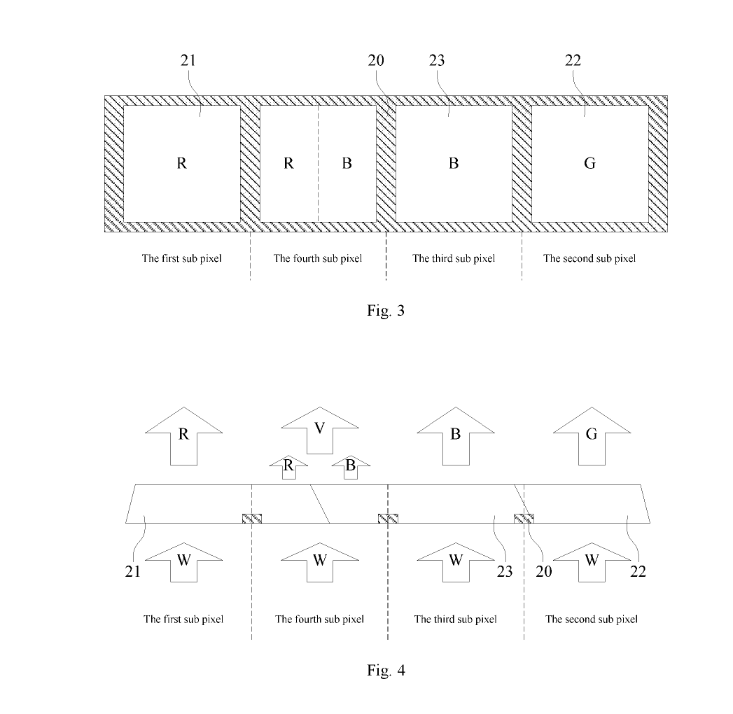

As shown in FIGS. 3 and 4, the embodiment of the present disclosure provides a pixel structure, which comprises sub pixels with four different colors. The first sub pixel is a red (R) sub pixel and provided with a red color-resist 21; the second sub pixel is a green (G) sub pixel and provided with a green color-resist 22; and the third sub pixel is a blue (B) sub pixel and provided with a blue color-resist 23. The fourth sub pixel is a violet (V) sub pixel and provided with the red color-resist 21 and the blue color-resist 23. In addition, the pixel structure further comprises a black matrix 20 that is used for separating two adjacent the sub pixels.

When an image is displayed, the backlight emits white (W) light. The white light is filtered by the red color-resist 21 when passing through the first sub pixel, and thus only red light transmits from the first sub pixel. The white light is filtered by the green color-resist 22 when passing through the second sub pixel, and thus only green light transmits from the second sub pixel. The white light is filtered by the blue color-resist 23 when passing through the third sub pixel, and thus only blue light transmits from the third sub pixel. The white light is filtered by the red color-resist 21 and the blue color-resist 23 respectively when passing through the fourth sub pixel, and thus red light and blue light transmit from the fourth sub pixel. The red light and the blue light are then mixed into violet light.

According to the present embodiment, in the fourth sub pixel, the red color-resist 21 and the blue color-resist 23 have a same area. That is, the red color-resist 21 and the blue color-resist 23 both account for a half of the fourth sub pixel. In this case, the red light transmitted from the fourth sub pixel and the blue light transmitted from the fourth sub pixel have the same area, so that the color shift of the violet light mixed therein can be reduced.

As a preferred solution, the fourth sub pixel is arranged between the first sub pixel and the third sub pixel. That is, the violet sub pixel is arranged between the red sub pixel and the blue sub pixel. In this manner, the red color-resist in the fourth sub pixel and the red color-resist in the first sub pixel can be formed into one piece, and the blue color-resist in the fourth sub pixel and the blue color-resist in the third sub pixel can also be formed into one piece, so that the patterning procedure during the manufacturing of the color filter substrate can be simplified.

In the pixel structure according to the embodiment of the present disclosure, the sub pixels with four different colors can be realized by the color-resists of three colors. Therefore, the color gamut thereof is widened, and the power consumption during display can be reduced. During the manufacturing of the color filter substrate, after the black matrix is formed, only the color-resists of three colors need to be formed in sequence. In this manner, the manufacturing procedure of the color filter substrate with four-color pixels can be simplified, the technical problem that the manufacturing of the color filter substrate with four-color pixels is complicated can be solved, and thus the production efficiency thereof can be improved. Moreover, no violet color-resist is used during the manufacturing of the color filter substrate, and thus the material cost thereof can be reduced.

### Embodiment 3

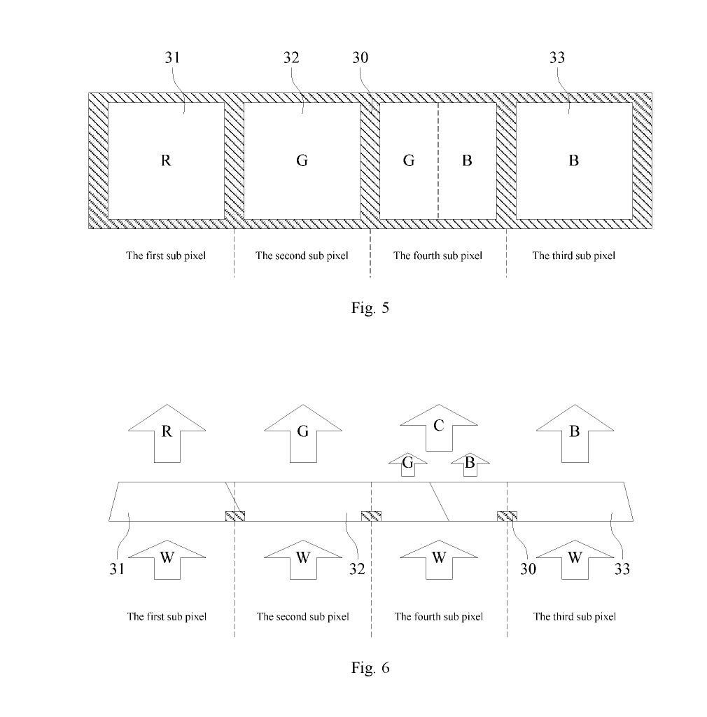

As shown in FIGS. 5 and 6, the embodiment of the present disclosure provides a pixel structure, which comprises sub pixels with four different colors. The first sub pixel is a red (R) sub pixel and provided with a red color-resist 31; the second sub pixel is a green (G) sub pixel and provided with a green color-resist 32; and the third sub pixel is a blue (B) sub pixel and provided with a blue color-resist 33. The fourth sub pixel is a cyan (C) sub pixel and provided with the green color-resist 32 and the blue color-resist 33. In addition, the pixel structure further comprises a black matrix 30 that is used for separating two adjacent the sub pixels.

When an image is displayed, the backlight emits white (W) light. The white light is filtered by the red color-resist 31 when passing through the first sub pixel, and thus only red light transmits from the first sub pixel. The white light is filtered by the green color-resist 32 when passing through the second sub pixel, and thus only green light transmits from the second sub pixel. The white light is filtered by the blue color-resist 33 when passing through the third sub pixel, and thus only blue light transmits from the third sub pixel. The white light is filtered by the green color-resist 32 and the blue color-resist 33 respectively when passing through the fourth sub pixel, and thus green light and blue light transmit from the fourth sub pixel. The green light and the blue light are then mixed into cyan light.

According to the present embodiment, in the fourth sub pixel, the green color-resist 32 and the blue color-resist 33 have a same area. That is, the green color-resist 32 and the blue color-resist 33 both account for a half of the fourth sub pixel. In this case, the green light transmitted from the fourth sub pixel and the blue light transmitted from the fourth sub pixel have the same area, so that the color shift of the cyan light mixed therein can be reduced.

As a preferred solution, the fourth sub pixel is arranged between the second sub pixel and the third sub pixel. That is, the cyan sub pixel is arranged between the green sub pixel and the blue sub pixel. In this manner, the green color-resist in the fourth sub pixel and the green color-resist in the second sub pixel can be formed into one piece, and the blue color-resist in the fourth sub pixel and the blue color-resist in the third sub pixel can also be formed into one piece, so that the patterning procedure during the manufacturing of the color filter substrate can be simplified.

In the pixel structure according to the embodiment of the present disclosure, the sub pixels with four different colors can be realized by the color-resists of three colors. Therefore, the color gamut thereof is widened, and the power consumption during display can be reduced. During the manufacturing of the color filter substrate, after the black matrix is formed, only the color-resists of three colors need to be formed in sequence. In this manner, the manufacturing procedure of the color filter substrate with four-color pixels can be simplified, the technical problem that the manufacturing of the color filter substrate with four-color pixels is complicated can be solved, and thus the production efficiency thereof can be improved. Moreover, no cyan color-resist is used during the manufacturing of the color filter substrate, and thus the material cost thereof can be reduced.

### Embodiment 4

The present disclosure further provides a display device, which can specifically be liquid crystal TV, liquid crystal display device, mobile phone, tablet personal computer, etc. The display device comprises a plurality of pixel units, and each of the pixel units comprises a pixel structure according to the above embodiments.

It should be noted that, in the present embodiment, the above Embodiment 1, Embodiment 2, and Embodiment 3 can be combined with one another. That is, one display device can comprise three kinds of pixel structures simultaneously according to the above Embodiment 1, Embodiment 2, and Embodiment 3.

Since the display device provided by the embodiment of the present disclosure has the same technical features as the pixel structure provided by the above embodiments, they can solve the same technical problem and achieve the same technical effect.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

1. A pixel structure, comprising sub pixels with four different colors, wherein:
a first sub pixel is provided with a first color-resist;
a second sub pixel is provided with a second color-resist;
a third sub pixel is provided with a third color-resist; and
a fourth sub pixel is provided with any two of said first color-resist, said second color-resist, and said third color-resist.

2. The pixel structure according to claim 1, wherein in said fourth sub pixel, two color-resists have a same area.

3. The pixel structure according to claim 1, wherein said first sub pixel is a red sub pixel, and said first color-resist is a red color-resist;
wherein said second sub pixel is a green sub pixel, and said second color-resist is a green color-resist; and
wherein said third sub pixel is a blue sub pixel, and said third color-resist is a blue color-resist.

4. The pixel structure according to claim 3, wherein said fourth sub pixel is a yellow sub pixel, and said yellow sub pixel is provided with the red color-resist and the green color-resist.

5. The pixel structure according to claim 4, wherein said yellow sub pixel is arranged between said red sub pixel and said green sub pixel.

6. The pixel structure according to claim 3, wherein said fourth sub pixel is a violet sub pixel, and said violet sub pixel is provided with the red color-resist and the blue color-resist.

7. The pixel structure according to claim 6, wherein said violet sub pixel is arranged between said red sub pixel and said blue sub pixel.

8. The pixel structure according to claim 3, wherein said fourth sub pixel is a cyan sub pixel, and said cyan sub pixel is provided with the blue color-resist and the green color-resist.

9. The pixel structure according to claim 8, wherein said cyan sub pixel is arranged between said blue sub pixel and said green sub pixel.

10. A display device, comprising a plurality of pixel units, each of said pixel units comprising a pixel structure, said pixel structure comprising sub pixels with four different colors, wherein:
a first sub pixel is provided with a first color-resist;
a second sub pixel is provided with a second color-resist;
a third sub pixel is provided with a third color-resist; and
a fourth sub pixel is provided with any two of said first color-resist, said second color-resist, and said third color-resist.

11. The display device according to claim 10, wherein in said fourth sub pixel, two color-resists have a same area.

12. The display device according to claim 10, wherein said first sub pixel is a red sub pixel, and said first color-resist is a red color-resist;
wherein said second sub pixel is a green sub pixel, and said second color-resist is a green color-resist; and
wherein said third sub pixel is a blue sub pixel, and said third color-resist is a blue color-resist.

13. The display device according to claim 12, wherein said fourth sub pixel is a yellow sub pixel, and said yellow sub pixel is provided with the red color-resist and the green color-resist.

14. The display device according to claim 13, wherein said yellow sub pixel is arranged between said red sub pixel and said green sub pixel.

15. The display device according to claim 12, wherein said fourth sub pixel is a violet sub pixel, and said violet sub pixel is provided with the red color-resist and the blue color-resist.

16. The display device according to claim 15, wherein said violet sub pixel is arranged between said red sub pixel and said blue sub pixel.

17. The display device according to claim 12, wherein said fourth sub pixel is a cyan sub pixel, and said cyan sub pixel is provided with the blue color-resist and the green color-resist.

18. The display device according to claim 17, wherein said cyan sub pixel is arranged between said blue sub pixel and said green sub pixel.
